(19) United States
(12) Patent Application Publication
(10) Pub. No.: US 2026/0023308 A1
(43) Pub. Date: Jan. 22, 2026

(54) ANGLE ADJUSTMENT APPARATUS AND MATTE BOX DEVICE

(71) Applicant: TILTA INC., Burbank, CA (US)

(72) Inventors: Shuangqiang YANG, Shenzhen (CN); Wenping ZENG, Shenzhen (CN); Kefeng ZHOU, Shenzhen (CN)

(21) Appl. No.: 19/269,629

(22) Filed: Jul. 15, 2025

(30) Foreign Application Priority Data
Jul. 17, 2024 (CN) 2024217060013

(51) Int. Cl. G03B 17/56; F16M 11/12

(52) U.S. Cl. CPC G03B 17/561; F16M 11/121; G03B 17/565

(57) ABSTRACT

An angle adjustment apparatus and a matte box device disclosed pertain to the technical field of photographic equipment accessories. The angle adjustment apparatus includes: a first connector with a connecting portion; a second connector rotatably connected to the first connector, featuring an installation portion; and an adjustment assembly. The adjustment assembly includes a first adjustment shaft, a second adjustment shaft, and a regulating part. The first adjustment shaft is rotatably positioned on the first connector, and the second adjustment shaft is rotatably positioned on the second connector. The regulating part is threadedly connected to at least one of the first adjustment shaft and the second adjustment shaft and is designed to adjust the spacing between the first adjustment shaft and the second adjustment shaft upon rotation.

### CROSS-REFERENCE TO RELATED APPLICATIONS

The present application for patent claims priority to and the benefit of pending Chinese Application No. 2024217060013, filed on Jul. 17, 2024, and hereby expressly incorporated by reference herein as if fully set forth below in its entirety and for all applicable purposes.

### TECHNICAL FIELD

The present application pertains to the technical field of photographic equipment accessories, specifically to an angle adjustment apparatus and a matte box device.

### INTRODUCTION

In the photography field, as shooting environments and requirements become increasingly varied, cameras are frequently mounted on installation bases such as stabilizers or gimbals and paired with various accessories to meet diverse shooting needs. For instance, a camera can be equipped with a matte box kit to enhance image quality and protect the lens. However, during use, it is often necessary to adjust the angle of the matte box kit within a certain range to fulfill user requirements. Therefore, there is a need for an adjustment apparatus that can meet the angle adjustment requirements for various accessories such as matte box kits.

### BRIEF SUMMARY

The present disclosure provides an angle adjustment apparatus and a matte box device that can meet the angle adjustment requirements for various accessories such as matte box kits.

According to a first aspect, one embodiment provides an angle adjustment apparatus, including:
a first connector with a connecting portion configured for fixation to a corresponding installation base;
a second connector rotatably connected to the first connector, featuring an installation portion for mounting a functional accessory; and
an adjustment assembly including a first adjustment shaft, a second adjustment shaft, and a regulating part; the first adjustment shaft is rotatably positioned on the first connector, and the second adjustment shaft is rotatably positioned on the second connector; and the regulating part is threadedly connected to at least one of the first adjustment shaft and the second adjustment shaft and is designed to adjust the spacing between the two adjustment shafts upon rotation.

### BRIEF DESCRIPTION OF THE DRAWINGS

FIG. 1 is a diagram illustrating a first view of an angle adjustment apparatus according to some aspects of the disclosure;

FIG. 2 is a diagram illustrating a second view of the angle adjustment apparatus of FIG. 1;

FIG. 3 is an exploded view illustrating the angle adjustment apparatus from a first perspective according to some aspects of the disclosure;

FIG. 4 is an exploded view of the angle adjustment apparatus from a second perspective;

FIG. 5 is a diagram illustrating the angle adjustment apparatus after angle adjustment according to some aspects of the disclosure;

FIG. 6 is an exploded view of a second connector according to some aspects of the disclosure;

FIG. 7 is a top view of the second connector according to some aspects of the disclosure;

FIG. 8 is a diagram illustrating a matte box device according to some aspects of the disclosure;

FIG. 9 is a diagram illustrating the angle adjustment apparatus configured as shown in FIG. 8;

FIG. 10 is an exploded view of the matte box device and the angle adjustment apparatus according to some aspects of the disclosure.

In the drawings:
100, first connector; 110, connecting portion; 111, anti-deflection groove; 112, anti-detachment latch; 120, mounting arm; 121, first hinge lug; 1211, ball detent; 122, moving groove;
200, second connector; 210, first connection unit; 211, second hinge lug; 2111, positioning hole; 212, limiting member; 2121, limiting portion; 2122, press portion; 213, flared portion; 2131, sliding groove; 2132, self-locking spring; 214, blind hole; 220, second connection unit; 221, installation portion; 2211, engaging lug; 2212, limiting boss; 222, rotary connection portion; 2221, limiting groove; 2222, avoidance groove; 223, auxiliary rotating shaft;
300, adjustment assembly; 310, first adjustment shaft; 320, second adjustment shaft; 330, regulating part; 331, rotation handle; 332, adjustment hole;
400, main rotating shaft;
500, tube clamp;
600, matte box kit; 601, limiting cavity.

### DETAILED DESCRIPTION

To clarify the objectives, technical solutions, and aspects of the present disclosure clearer, the following detailed description is provided in conjunction with the accompanying drawings and exemplary embodiments. It should be understood that the specific embodiments described herein are merely for illustrative purposes and do not limit the scope of the present disclosure.

In some aspects of the present application, by establishing a rotatable connection between a first connector 100 and a second connector 200, the first connector 100 can be fixedly mounted to a corresponding installation base, while the second connector 200 can be used to mount various accessories such as a matte box kit 600. Working in conjunction with the first connector 100 and the second connector 200, an adjustment assembly 300 enables the adjustment of the rotation angle between the two connectors, thereby fulfilling the angle adjustment requirements for various accessories such as the matte box kit 600 during use.

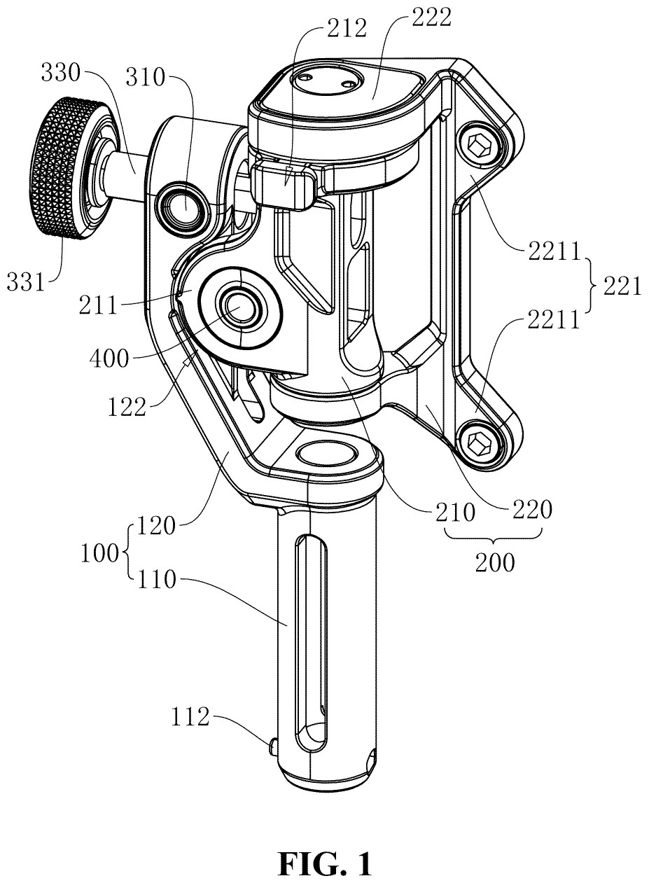

In some aspects, referring to FIGS. 1-7, an angle adjustment apparatus includes a first connector 100, a second connector 200, and an adjustment assembly 300. The first connector 100 has a connecting portion 110 for mounting to a corresponding installation base. The second connector 200 is rotatably connected to the first connector 100 and features an installation portion 221 for mounting an accessory. The adjustment assembly 300 is used to adjust the angle between the first connector 100 and the second connector 200, thereby enabling angle adjustment of the accessory mounted on the second connector 200 during use.

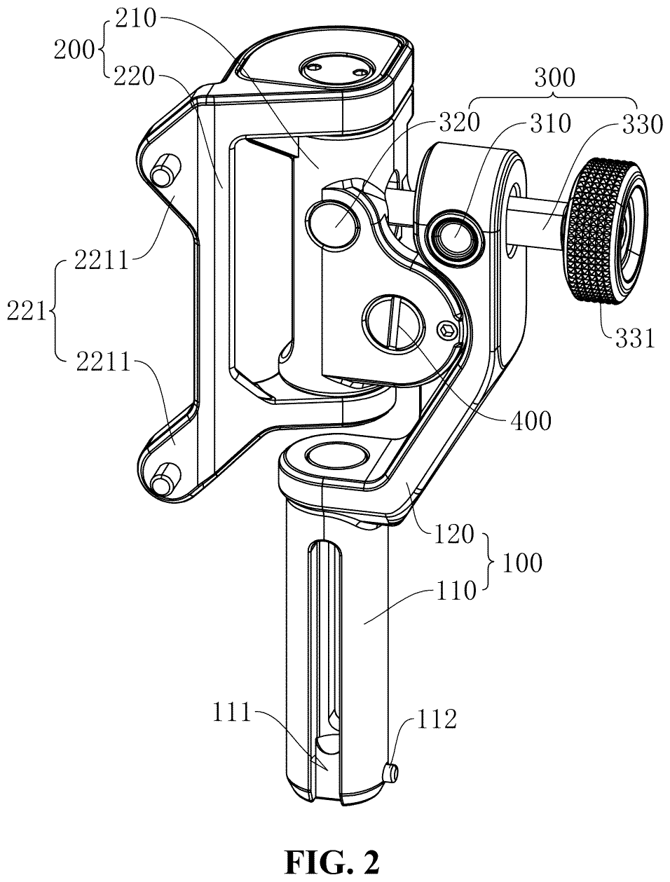

Regarding the first connector 100, exemplarily, referring to FIGS. 1-2, the first connector 100 includes a connecting portion 110 and a mounting arm 120. The connecting portion 110 can be a columnar structure, and the mounting arm 120 is fixedly connected to one end of the connecting portion 110. An anti-deflection groove 111 is provided on one side of the connecting portion 110, extending along its length to the end face away from the mounting arm 120. During use, the connecting portion 110 can be inserted and fixed to the corresponding installation base and circumferentially positioned by engaging with a positioning protrusion on the installation base. The second connector 200 is rotatably mounted on the mounting arm 120.

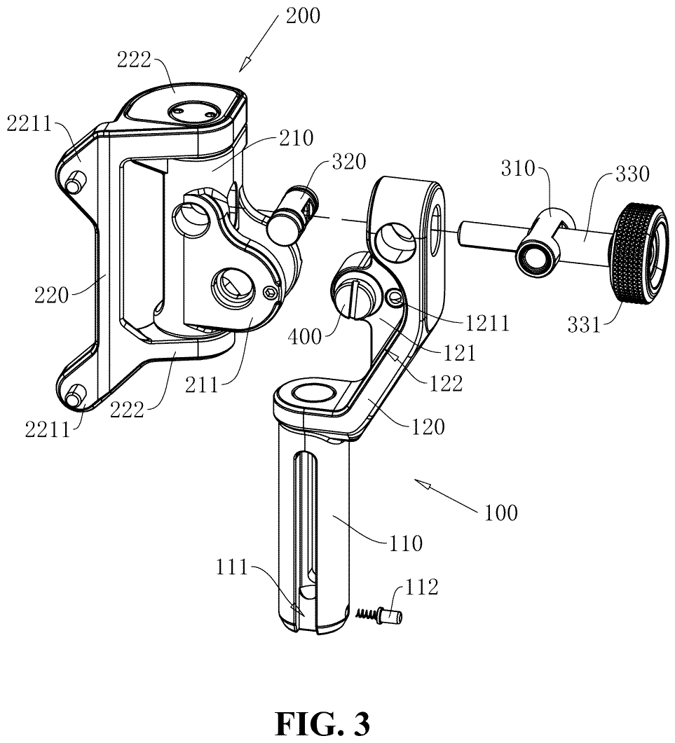

Although the columnar structure of the connecting portion 110 allows it to be inserted and fixed to the corresponding installation base, there is a risk of axial detachment during use. Therefore, in some embodiments, referring to FIGS. 2-3, an anti-detachment latch 112 can be provided at the end of the connecting portion 110. The anti-detachment latch can switch between an anti-detachment state and an installation state. The anti-detachment latch 112 can be movably embedded in the sidewall of the connecting portion 110 and has a detachment-preventing state where it protrudes partially from the sidewall and an installation state where it retracts into the connecting portion 110. In the detachment-preventing state, the anti-detachment latch 112 forms axial retention with the installation base to prevent detachment of the connecting portion 110. In the installation state, the protruding part of the anti-detachment latch 112 retracts into the connecting portion 110, facilitating insertion and fixation to the corresponding installation base. In some aspects, the anti-detachment latch 112 can be a spring pin installed on the sidewall of the connecting portion 110 away from the mounting arm 120. When inserting the connecting portion 110 into the corresponding installation base, the protruding part of the spring pin can be pressed into the connecting portion 110 (even in the installation state). Once the spring pin passes through the insertion hole on the corresponding installation base, the pressing force is released, and the spring pin automatically returns to the detachment-preventing state. In other examples, other anti-detachment structures compatible with the corresponding installation base can also be adopted, provided they meet design and usage requirements.

Regarding the second connector 200, in one embodiment, referring to FIGS. 1-2, the second connector 200 includes a first connection unit 210 and a second connection unit 220. The first connection unit 210 is rotatably connected to the first connector 100, while the second connection unit 220 is connected to the first connection unit 210, with an installation portion 221 provided on the second connection unit 220. In different embodiments, the second connection unit 220 and the first connection unit 210 can be configured as either fixed or rotatable connections based on design and usage requirements.

In some aspects, referring to FIGS. 1-3, the first connector 100 is provided with a first hinge lug 121, while the second connector 200 is provided with two spaced-apart second hinge lugs 211 (e.g., brackets). The first hinge lug 121 is positioned between the two second hinge lugs 211, and a main rotating shaft 400 is inserted through the first hinge lug 121 and the two second hinge lugs 211, thereby rotatably connecting the first hinge lug 121 and the second hinge lugs 211 via the main rotating shaft 400.

In some aspects, referring to FIGS. 1-3, the mounting arm 120 of the first connector 100 is provided with a moving groove 122, and the first hinge lug 121 is disposed within the moving groove 122. The two second hinge lugs 211 can be integrally formed on the first connection unit 210, with the first hinge lug 121 sandwiched between the two second hinge lugs 211. Both the first hinge lug 121 and the second hinge lugs 211 are provided with lug holes for the insertion of the main rotating shaft 400. The main rotating shaft 400 passes through the lug holes of the first hinge lug 121 and the second hinge lugs 211, thereby enabling a rotatable connection between the mounting arm 120 and the first connection unit 210. The first hinge lug 121 is located at about the center of the moving groove 122, such that the moving groove 122 provides assembly space on both sides of the first hinge lug 121 for the second hinge lugs 211. Additionally, the second hinge lugs 211 and the groove walls of the moving groove 122 can be provided with matching curved surfaces, enabling the groove walls to assist in supporting the first connection unit 210 via the second hinge lugs 211, thereby helping to distribute the connection load on the main rotating shaft 400.

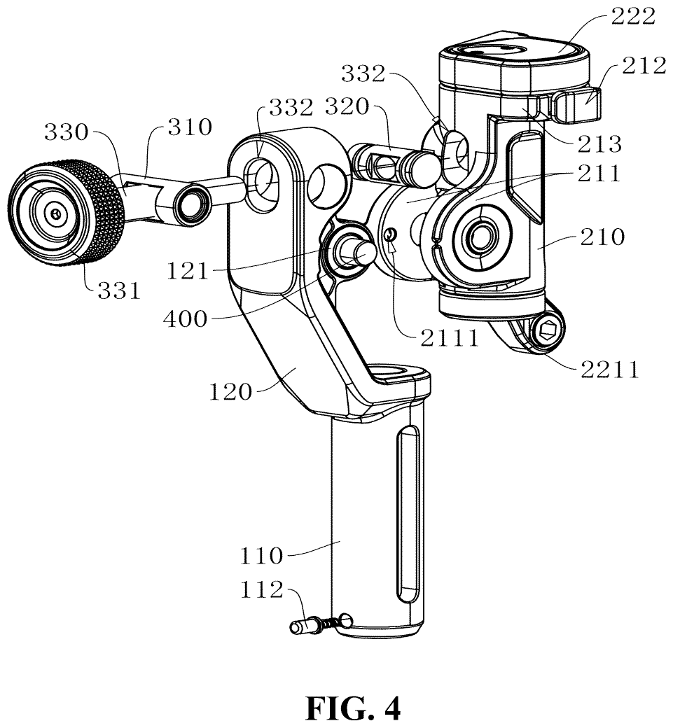

In some aspects, referring to FIGS. 3-4, the first hinge lug 121 can be equipped with a ball detent 1211, while the second hinge lugs 211 can be furnished with positioning holes 2111 designed to receive the ball detent 1211. For users, the angle between the first connection unit 210 and the first connector 100, when the ball detent 1211 engages with the positioning hole 2111, can serve as an initial reference angle. Starting adjustments from this angle aids users in determining the adjusted angle value, providing a reference for similar angle adjustment needs.

In some aspects, the ball detent 1211 can be embedded in the sidewall of the first hinge lug 121, with its surface slightly protruding from the sidewall. The positioning hole 2111 can be located on the sidewall of the second hinge lug 211 facing the ball detent 1211.

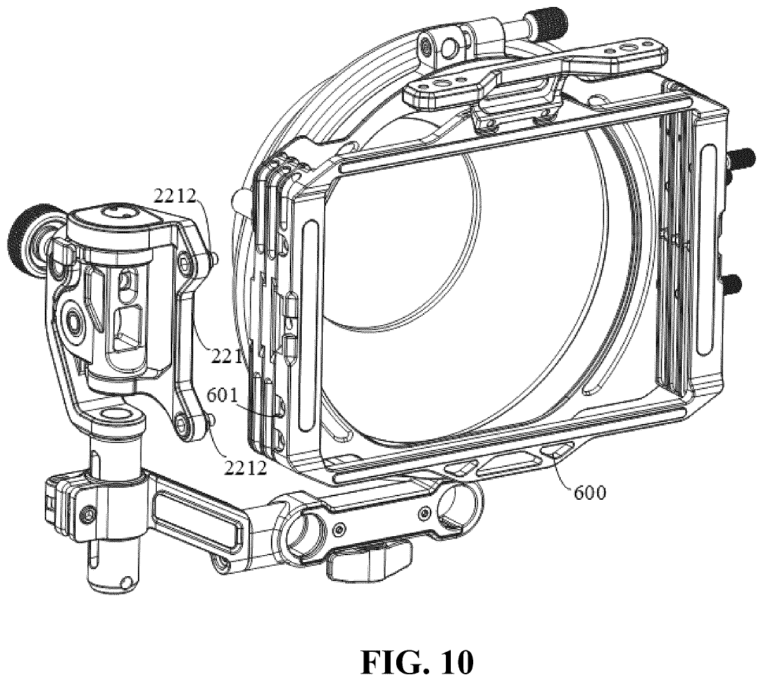

In some aspects, as shown in FIGS. 2-3, the installation portion 221 can include two spaced-apart engaging lugs 2211, which are coplanar and feature mounting holes for fasteners such as bolts. The matte box kit 600 can be mounted to the installation portion 221 using these fasteners. In certain embodiments, the installation portion 221 can include fasteners like bolts. Alternatively, other installation structures that meet design and usage requirements can be used as the installation portion 221. In some aspects, referring to FIG. 10, the bolt is further equipped with a limiting boss 2212, while the matte box kit 600 has a limiting cavity 601. When the user uses the bolt for installation, the bolt engages with a threaded hole on the matte box kit, and the limiting boss 2212 fits into the limiting cavity 601, thereby limiting the connection between the installation portion 221 and the matte box kit 600 and enhancing structural stability.

Referring to FIGS. 2-4, the adjustment assembly 300 includes a first adjustment shaft 310, a second adjustment shaft 320, and a regulating part 330. The first adjustment shaft 310 is rotatably positioned at the first connector 100, while the second adjustment shaft 320 is rotatably positioned at the second connector 200. The regulating part 330 is threadedly connected to at least one of the first adjustment shaft 310 and the second adjustment shaft 320 to adjust the spacing between the first adjustment shaft 310 and the second adjustment shaft 320 upon rotation, thereby enabling angle adjustment between the first connector 100 and the second connector 200.

In some aspects, the first adjustment shaft 310 and the second adjustment shaft 320 can be configured as either cylindrical or spherical structures. If cylindrical, the first adjustment shaft 310 and the second adjustment shaft 320 can be arranged in parallel or nearly parallel to the rotation axis of the second connector 200 to ensure an adequate range of rotation for the second connector 200.

In some aspects, the regulating part 330 is threadedly connected to both the first adjustment shaft 310 and the second adjustment shaft 320, with opposite thread directions for the respective threaded sections.

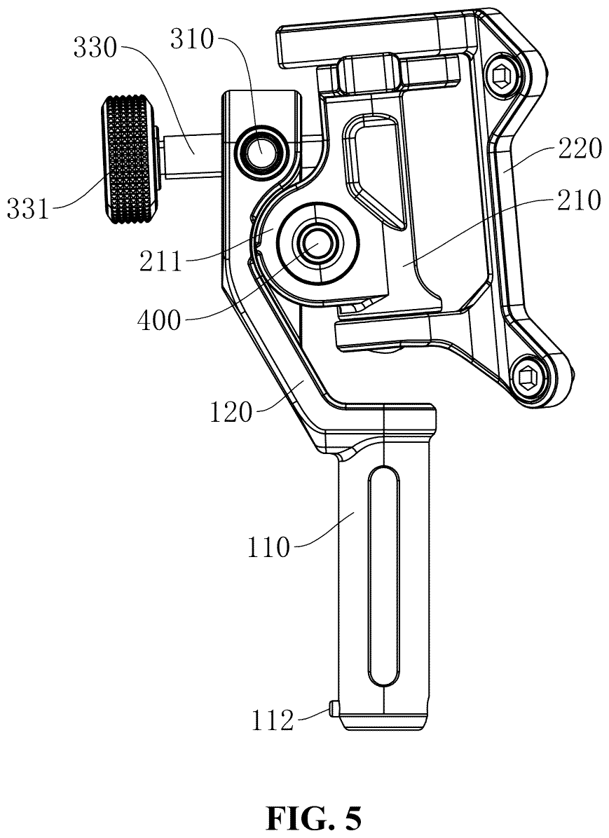

In some aspects, as shown in FIGS. 2-4, the first adjustment shaft 310 is rotatably connected to the mounting arm 120, while the second adjustment shaft 320 is rotatably mounted on the first connection unit 210. Both the first adjustment shaft 310 and the second adjustment shaft 320 are offset from the main rotating shaft 400. One end of the regulating part 330 passes through the first adjustment shaft 310 and is threadedly connected to the second adjustment shaft 320, while also being threadedly connected to the first adjustment shaft 310 with opposite thread directions. This setup ensures that rotating the regulating part 330 causes the first adjustment shaft 310 and the second adjustment shaft 320 to move closer or farther apart while rotating about their own axes (as shown in FIG. 5), accommodating changes in the relative position between the first adjustment shaft 310 and the second adjustment shaft 320 due to angular adjustments between the first connection unit 210 and the mounting arm 120.

In some aspects, the regulating part 330 can be designed to threadedly connect only to the first adjustment shaft 310, with one end passing through the first adjustment shaft 310 and rotatably connected to the second adjustment shaft 320, forming a rotatable axial restriction between the regulating part 330 and the second adjustment shaft 320. In this case, rotating the regulating part 330 similarly moves the second adjustment shaft 320 toward or away from the first adjustment shaft 310, enabling angle adjustment between the first connection unit 210 and the mounting arm 120. Alternatively, the regulating part 330 may threadedly connect only to the second adjustment shaft 320, with one end passing through the second adjustment shaft 320 and rotatably connected to the first adjustment shaft 310, achieving the same adjustment functionality for the first connection unit 210 and the mounting arm 120.

In some aspects, the regulating part 330 can feature a threaded segment and a connecting segment that are coaxially and rotatably connected. The threaded segment is threadedly engaged with one of the first adjustment shaft 310 and the second adjustment shaft 320, while the connecting segment is fixedly connected to the other. By rotating the threaded segment, the angle between the first connection unit 210 and the mounting arm 120 can be adjusted.

The adjustment holes 332 provided on the mounting arm 120 and the first connection unit 210 for the passage of the regulating part 330 have sufficient clearance to accommodate the deflection of the regulating part 330 during adjustment. In some aspects, referring to FIG. 4, the adjustment holes 332 can be configured as waist-type holes (e.g., a hole with a narrowed or constricted middle section).

In some aspects, a rotation handle 331 can be installed at the end of the regulating part 330 for adjustment to facilitate manual rotation.

In some aspects, to facilitate the replacement of components on various accessories such as the matte box kit 600, as shown in FIGS. 5-7, the second connection unit 220 is rotatably connected to the first connection unit 210. When components on the accessory need to be replaced, the second connection unit 220 can be rotated relative to the first connection unit 210 to provide greater working space for installation or replacement.

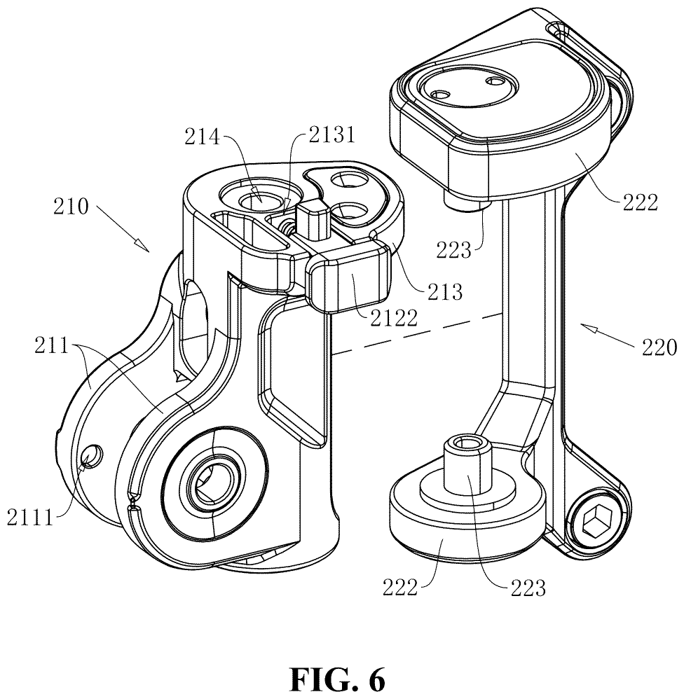

In some aspects, referring to FIGS. 5-6, the second connection unit 220 includes a rotary connection portion 222 provided with an auxiliary rotating shaft 223, through which the second connection unit 220 is rotatably connected to the first connection unit 210. In some aspects, both ends of the second connection unit 220 can be equipped with rotary connection portions 222, each having an auxiliary rotating shaft 223 on the opposing sides. The two auxiliary rotating shafts 223 are coaxially arranged, with their axes perpendicular to that of the main rotating shaft 400. Both ends of the first connection unit 210 are provided with blind holes 214 for rotatably engaging with the auxiliary rotating shafts 223. In other embodiments, alternative rotational connection methods can be employed between the second connection unit 220 and the first connection unit 210.

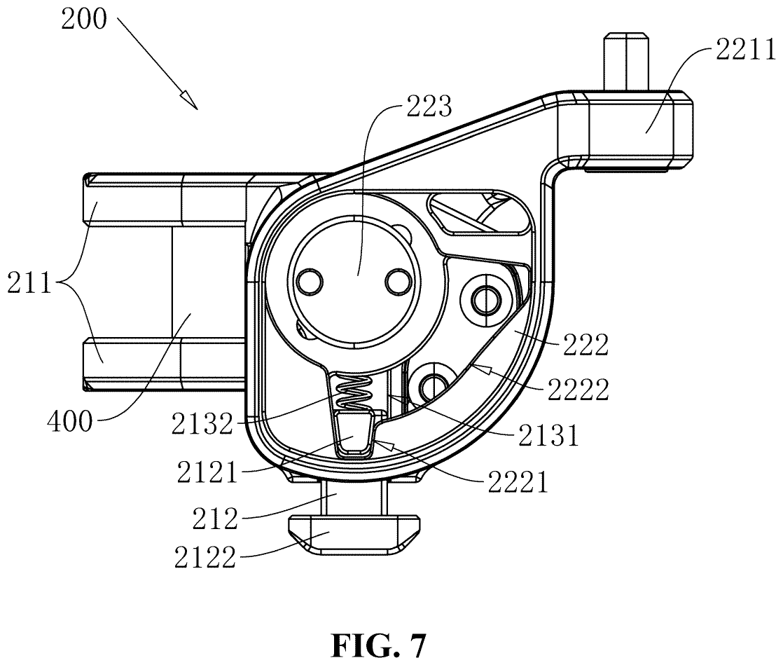

In some aspects, referring to FIGS. 6-7, a limiting member 212 can be movably positioned on either the first connection unit 210 or the rotary connection portion 222. The limiting member 212 can switch between an unlocked state and a locked state. In the locked state of the limiting member 212, the second connection unit 220 is secured to the first connection unit 210, while in the unlocked state of the limiting member 212, the second connection unit 220 can rotate relative to the first connection unit 210.

This configuration allows the limiting member 212 to be switched to the unlocked state when components of the accessories need to be installed or replaced, enabling the second connection unit 220 to rotate to a suitable position. After replacement, the second connection unit 220 can be reset, and the limiting member 212 can be returned to the locked state, restoring the angle adjustment apparatus to normal operation. This design not only facilitates component installation and replacement but also prevents undesired deflection of the second connection unit 220 during normal use.

In some aspects, with reference to FIGS. 6-7, the limiting member 212 can be movably arranged at one end of the first connection unit 210 adjacent to the rotary connection portion 222. The limiting member 212 includes a limiting portion 2121, and the rotary connection portion 222 is equipped with a limiting groove 2221 and an avoidance groove 2222. The limiting groove 2221 and the avoidance groove 2222 are interconnected, with the limiting groove 2221 (e.g., recess) being provided in the avoidance groove 2222 away from the auxiliary rotating shaft 223. In the locked state of the limiting member 212, the limiting portion 2121 is located within the limiting groove 2221, while in the unlocked state of the limiting member 212, the limiting portion 2121 moves into the avoidance groove 2222.

In some aspects, with reference to FIGS. 6-7, a flared portion 213 is provided at one end of the first connection unit 210 adjacent to the rotary connection portion 222. A sliding groove 2131 is formed radially along the blind hole 214 on the side of the flared portion 213 facing the rotary connection portion 222. The limiting member 212 is slidably arranged within the sliding groove 2131, with one end protruding from the sliding groove 2131 to form a press portion 2122 and the other end having the limiting portion 2121, which extends beyond the sliding groove 2131 towards the rotary connection portion 222. The limiting groove 2221 and the avoidance groove 2222 are situated on the rotary connection portion 222 near the flared portion 213. The limiting groove 2221 is situated at one end of the avoidance groove 2222, forming a recess on the groove wall of the avoidance groove 2222 away from the auxiliary rotating shaft 223. In the locked state of the limiting member 212, the limiting portion 2121 engages within the limiting groove 2221. When the limiting member 212 is switched to the unlocked state, the limiting portion 2121 moves into the avoidance groove 2222, enabling the second connection unit 220 to rotate as the avoidance groove 2222 shifts to various positions within the avoidance groove 2222 accordingly.

In some aspects, to prevent accidental unlocking during use, with reference to FIGS. 6-7, the limiting member 212 can be elastically situated within the first connection unit 210, biasing it towards the locked state. In the present disclosure, the term “elastically situated” refers to configurations that employ springs, elastic materials, or resilient structures for connection or abutment. In some examples, the limiting member 212 can employ springs, elastic materials, or resilient structures to be biased towards the locked state.

In some aspects, with reference to FIGS. 6-7, the limiting member 212 can be elastically situated within the first connection unit 210 via a self-locking spring 2132. In some aspects, the self-locking spring 2132 can be arranged within the sliding groove 2131 along its length direction between the limiting member 212 and the groove wall adjacent to the blind hole 214, thus applying an elastic force (away from the blind hole 214) to the limiting member 212 to keep the limiting portion 2121 in the locked state.

In some aspects, the limiting member 212 can be slidably arranged on the rotary connection portion 222, with the limiting groove 2221 and avoidance groove 2222 provided on the first connection unit 210.

In some aspects, the limiting member 212 can be implemented as a bolt, locking pin, or a similar structural member. For example, the limiting member 212 is configured as a bolt threadedly connected to either the first connection unit 210 or the rotary connection portion 222. By adjusting the bolt to abut against the corresponding rotary connection portion 222 or first connection unit 210, the rotation of the second connection unit 220 can also be locked.

In some aspects, various configurations can be adopted without the limiting member 212 to constrain the rotation of the second connection unit 220. For example, the auxiliary rotating shaft 223 can be threadedly connected to the rotary connection portion 222. By rotating the auxiliary rotating shaft 223, its axial position can be adjusted to control the degree of abutment between the auxiliary rotating shaft 223 and the wall of the blind hole 214. This setup ensures that the second connection unit 220 can only be rotated when a great force is deliberately applied to it.

In some aspects, weight reduction grooves can be formed on the first connector 100 and the second connector 200 to decrease the overall weight, thereby improving the portability and usability of the angle adjustment apparatus.

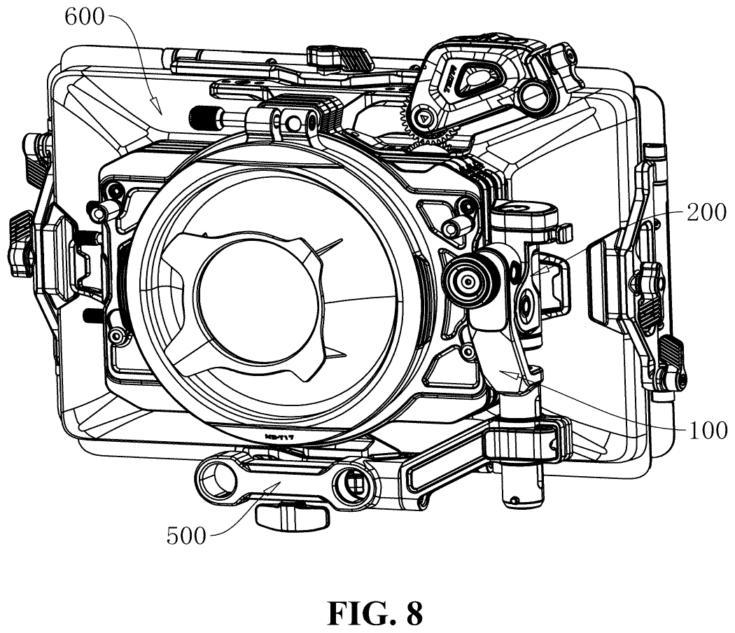

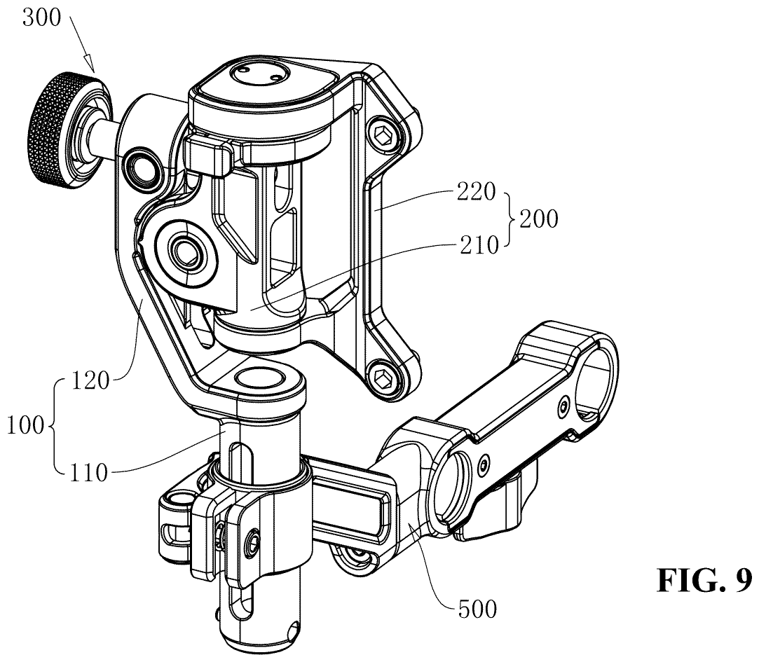

In some aspects, referring to FIGS. 8 and 9, the device includes a matte box kit 600 and the angle adjustment apparatus. The connecting portion 110 includes a tube clamp 500 for attachment to a corresponding mounting base, allowing the angle adjustment apparatus to be securely mounted via the tube clamp 500 for subsequent installation of the matte box kit 600. The angle adjustment apparatus can incorporate any of the previously mentioned embodiments and is capable of securing the matte box kit 600.

The term “mounting base” in this disclosure may refer to a stabilizer or tripod head, or alternatively to a stabilizer or tripod head equipped with one or more circular tubes for attaching the tube clamp 500. Taking a tripod head as an example, the circular tube can be installed on the tripod head via a base, with the tube clamp 500 attached to the circular tube. In summary, any structural component capable of supporting the angle adjustment apparatus or matte box device described herein can be considered a mounting base.

In some aspects, while the angle adjustment apparatus and tube clamp 500 in this disclosure are designed to meet the angle adjustment requirements for using the matte box kit 600, this does not mean that they are exclusively compatible with the matte box kit 600. In practice, they can also be used in conjunction with other accessories requiring angle adjustment. Therefore, it should be understood that the matte box kit 600 mentioned herein does not restrict the inventive concept of angle adjustment apparatus disclosed in this disclosure; it merely represents one application scenario. Configurations combined with other accessories also fall within the protection scope of this disclosure.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. An angle adjustment apparatus, comprising:
a first connector is provided with a connecting portion, wherein the connecting portion is configured for installation at a corresponding mounting base;
a second connector rotatably connected to the first connector, wherein the second connector is provided with an installation portion configured to install an accessory; and
an adjustment assembly comprising a first adjustment shaft, a second adjustment shaft, and a regulating part;
wherein the first adjustment shaft is rotatably provided at the first connector;
wherein the second adjustment shaft is rotatably provided at the second connector;
wherein the regulating part is connected to at least one of the first adjustment shaft or the second adjustment shaft, and
wherein rotation of the regulating part is configured to adjust an angle between the first connector and the second connector in response to a rotation of the regulating part.

2. The angle adjustment apparatus according to claim 1, wherein the first adjustment shaft and the second adjustment shaft are respectively threadedly to the regulating part; and
wherein threads engaging the first adjustment shaft and threads engaging the second adjustment shaft are configured with opposite helical directions.

3. The angle adjustment apparatus according to claim 1, wherein the first connector is provided with a first hinge lug;
wherein the second connector is provided with two spaced-apart second hinge lugs;
wherein the first hinge lug is provided between the two spaced-apart second hinge lugs;
wherein a main rotating shaft passes through the first hinge lug and the two spaced-apart second hinge lugs; and
wherein the first hinge lug and the two spaced-apart second hinge lugs are rotatably connected via the main rotating shaft.

4. The angle adjustment apparatus according to claim 3, wherein the first hinge lug is provided with a ball detent; and
wherein each of the two spaced-apart second hinge lugs is provided with a positioning hole configured to receive the ball detent.

5. The angle adjustment apparatus according to claim 1, wherein the second connector comprises:
a first connection unit rotatably connected to the first connector; and
a second connection unit rotatably connected to the first connection unit, wherein the installation portion is provided on the second connection unit.

6. The angle adjustment apparatus according to claim 5, wherein the second connection unit comprises a rotary connection portion provided with an auxiliary rotating shaft;
wherein the second connection unit is rotatably connected to the first connection unit via the auxiliary rotating shaft;
wherein a limiting member is movably disposed on one of the first connection unit and the rotary connection portion;
wherein the limiting member is configured to switch therebetween an unlocked state and a locked state;
wherein in the locked state, the second connection unit is locked relative to the first connection unit; and
wherein in the unlocked state, the second connection unit is rotatable relative to the first connection unit.

7. The angle adjustment apparatus according to claim 6, wherein the limiting member is movably provided at an end of the first connection unit adjacent to the rotary connection portion;
wherein the limiting member comprises a limiting portion;
wherein the rotary connection portion is provided with a limiting groove and an avoidance groove in communication;
wherein the limiting groove is provided in the avoidance groove distal to the auxiliary rotating shaft;
wherein in the locked state, the limiting portion being provided in the limiting groove; and
wherein in the unlocked state, the limiting portion being provided in the avoidance groove.

8. The angle adjustment apparatus according to claim 7, wherein the limiting member is elastically provided on the first connection unit, and wherein the limiting member is configured to apply an elastic force to keep the limiting portion in the locked state.

9. The angle adjustment apparatus according to claim 1, wherein the connecting portion comprises a columnar structure configured for fixed insertion into a corresponding mounting base;
wherein an end of the connecting portion is provided with an anti-detachment latch movably embedded in a side wall of the connecting portion;
wherein the anti-detachment latch is configured to switch between an anti-detachment state and an installation state;
wherein in the anti-detachment state, the anti-detachment latch is configured to partially protrude from the side wall of the connecting portion; and
wherein in the installation state, the anti-detachment latch is configured to retract into the connecting portion.

10. A matte box device, comprising:
a matte box kit and the angle adjustment apparatus according to claim 1;
wherein the connecting portion further comprises a tube clamp configured for installation of a corresponding mounting base to secure the connecting portion; and
wherein the installation portion is configured to install the matte box kit.
